(19) United States
(12) Patent Application Publication
(10) Pub. No.: US 2011/0290609 A1
(43) Pub. Date: Dec. 1, 2011

(54) TRANSMISSION HAVING SEVERAL FRICTIONALLY ENGAGED SHIFTING ELEMENTS

(75) Inventors: Peter Ziemer, Tettnang (DE); Gerhard Gumpoltsberger, Friedrichshafen (DE); Mark Mohr, Tettnang (DE)

(73) Assignee: ZF FRIEDRICHSHAFEN AG, Friedrichshafen (DE)

(21) Appl. No.: 13/143,385

(22) PCT Filed: Feb. 11, 2010
(86) PCT No.: PCT/EP2010/051721

§ 371 Date: Jul. 6, 2011

(30) Foreign Application Priority Data
Feb. 24, 2009 (DE) 102009001101.3

(51) Int. Cl. F16D 21/00; F16D 13/60

(52) U.S. Cl. 192/48.1

(57) ABSTRACT

A transmission (1) having a plurality of frictionally engaging shift elements (A to C) which are engaged or disengaged in order to obtain various gear ratios. The permissible surface pressure in the area of friction surfaces of connecting elements (B, C) that can be brought into mutual frictional engagement, which are engaged during upshifts to produce a gear ratio, is lower than the permissible surface pressure in the area of friction surfaces of disconnecting elements (A) that can be brought into mutual frictional engagement which, in each case, are only disengaged during upshifts to produce gear ratios.

This application is a National Stage completion of PCT/EP2010/051721 filed Feb. 11, 2010, which claims priority from German patent application serial no. 10 2009 001 101.3 filed Feb. 24, 2009.

### FIELD OF THE INVENTION

The invention concerns a transmission having several frictionally engaged shifting elements.

### BACKGROUND OF THE INVENTION

From DE 102 44 023 A1 a transmission, in particular an automatic transmission is known, which has several shift elements and several gearwheels that can be connected into a power flow by means of the shift elements. To produce a gear ratio, in each case at least one of the shift elements is engaged. The shift elements engaged during upshifts are in the form of frictionally engaging shift elements, whereas the shift elements which, in upshifts, are in each case ones only to be disengaged, are in the form of interlocking shift elements.

By using interlocking shift elements or claw shift elements instead of frictional shift elements, which are disengaged during traction upshifts and are not engaged again during any further traction upshift, drag torques that impair the efficiency of the transmission and shift element slipping phases characterized by high loads are reduced, and the control of the transmission is simplified.

The replacement of frictionally engaging shift elements with interlocking shift elements is based on the knowledge that in contrast to interlocking shift elements, frictional shift elements made with lining disks enable comfortable shifts to be carried out in a transmission or an automatic transmission by virtue of a frictional coefficient variation that can be obtained in a defined manner. However, this advantage can only be achieved at the cost of high thermal loading in the area of the lining disks, which moreover are subjected to wear that shortens the useful life of a frictionally engaging shift element.

Furthermore, in the area of the lining disks of frictional shifting elements in automatic transmissions the permissible surface pressure is limited, so the frictional shift elements have to be made with correspondingly large friction surfaces in order to be able to transmit the torque applied in each case. In the area of the friction surfaces that have to be made correspondingly large, in contrast to interlocking shift elements, in the disengaged operating condition of the frictional shift elements, drag torques are produced which, as is known, impair the efficiency of the transmission.

However, in contrast to frictional shift elements, interlocking shift elements can only be engaged essentially when close to their synchronous point and during at least approximately load-free operating conditions. Thus, various gearset systems cannot be operated to the desired extent without an additional separator clutch between an internal combustion engine and a transmission. Moreover, rotational speed differences in transmissions in the area of interlocking shift elements cannot be equalized as with frictional shift elements during slipping operation within predefined shifting times. Thus, in transmissions interlocking shift elements can only be used in areas of the transmission in which the friction power or friction work to be performed during shift operations is essentially equal to zero, so that the functionality of the transmission with interlocking shift elements is available only in an undesirably restricted operating range.

### SUMMARY OF THE INVENTION

Accordingly, the purpose of the present invention is to provide a transmission which can be operated with high efficiency and whose functionality is available in a larger operating range compared with transmissions known from the prior art.

The transmission according to the invention is constructed with several frictionally engaging shift elements, which are engaged or disengaged for obtaining various gear ratios.

According to the invention, the permissible surface pressure in the area of friction surfaces of connecting shift elements that can be brought into frictional engagement with one another, which are engaged in traction upshifts in order to obtain a gear ratio, is lower than the permissible surface pressure in the area of friction surfaces of disconnecting shift elements that can be brought into frictional engagement with one another, which are in each case only disengaged during upshifts in order to obtain gear ratios.

The disconnecting elements, which in upshifts are in each case only disengaged to produce gear ratios, are exposed to little thermal loading during operation of the transmission. This results from the fact that during upshifts, especially during traction upshifts, the disconnecting elements can be disengaged without slip and within a very short time without adverse effect on the shifting comfort. For this reason the friction variation to be produced in the area of the disconnecting elements is of secondary importance for the shift sequence of an upshift or traction upshift.

This offers the possibility, in the area of the friction surfaces of disconnecting shift elements, of providing a higher permissible surface pressure and, to transmit a torque applied in each case, of making the necessary friction surfaces of the disconnecting shift elements smaller compared with connecting elements and thereby reducing the structural space requirement of the disconnecting elements and the transmission. In turn, the result of the smaller friction surfaces is that during operation of the transmission, in the area of the disconnecting shift elements made as frictional shift elements, drag torques are low and the transmission can be operated with high efficiency.

Compared with transmissions known from the prior art, which have disconnecting elements in the form of interlocking shift elements, in the transmission according to the invention there is in the area of the disconnecting elements the additional possibility despite this of carrying out an operation-condition-dependent synchronization by means of the disconnecting elements. This results from the fact that in contrast to interlocking shift elements, in the area of frictional shift elements slipping operation can be carried out and rotational speed differences in the transmission in the area of the frictional shift elements can if necessary be at least approximately equalized. Consequently, compared with transmissions known from the prior art the functionality of the transmission is available over a larger operating range.

Thus for example, the disconnecting elements can be made as unlined frictional shift elements, which in comparison to frictional shift elements having lining disks, can be configured with a substantially larger air gap which, as is known, has a far from negligible influence on drag torques occurring in the area of a frictional shift element.

Owing to the substantially lower thermal loading in the area of the disconnecting elements compared with the connecting elements, the structural components of the disconnecting elements made with friction surfaces can be made more compact and inexpensive, with smaller component thicknesses and also low component weight.

Owing to the substantially lower thermal loading compared with connecting elements, depending on the application in each case it may even be possible to do without a defined oil through-flow in the area of the disconnecting elements, so that a transmission oil pump has to provide a smaller hydraulic fluid volume flow and can therefore also be operated with lower output power.

In an advantageous further development of the transmission according to the invention, the disconnecting elements are in the form of disk shift elements whose outer disks are made at least in sections as cup springs, in each case in their outer edge area, and whose inner disks are made at least in sections as cup springs, in each case in their inner edge area. In this way, in a simply designed manner the inner and outer disks of the disconnecting elements are kept a distance apart from one another in the disengaged operating condition of the disconnecting elements and drag torques occurring in the disengaged operating condition of the disconnecting elements are reduced to a minimum.

In an advantageous further development of the transmission according to the invention, the cup-spring-like edge areas of the inner and outer disks of the disconnecting elements overhang the friction surfaces of the inner and outer disks, respectively in different axial directions, whereby in a simple manner the assembly of the transmission or its disconnecting elements is simplified.

In further advantageous embodiments of the transmission according to the invention, at least the friction surfaces of the disconnecting elements are made from materials with a high friction coefficient such as steel, a sintered powder material, molybdenum, ceramic, aluminum or the like, so that respective desirably high permissible surface pressures can be applied in the area of the disconnecting elements.

In a further advantageous embodiment of the transmission according to the invention, at least one of the disk-shaped disconnecting elements is of conical form, such that for friction surfaces of the same size, compared with flat friction surfaces, the friction torques that can be made available are higher. In a simple manner this makes it possible, for the same transmission capacity, to make the friction surfaces of a disconnecting element that can be brought into mutual engagement even smaller, and thus to farther reduce the drag torques which impair the efficiency of a transmission.

### BRIEF DESCRIPTION OF THE DRAWINGS

Other advantages and advantageous further developments of the invention emerge from the claims and from the example embodiments whose principle is described with reference to the drawings; for the sake of clarity, in the description of the various example embodiments the same indexes are in each case used for components having the same structure and function.

The drawings show:

FIG. 1: A schematic partial longitudinally sectioned view of a transmission with a plurality of frictionally engaging shift elements;

FIG. 2: An alternative embodiment of a disconnecting element of the transmission shown in FIG. 1; and

FIG. 3: A detailed view of an outer and inner disk of the disconnecting element in FIG. 2.

### DETAILED DESCRIPTION OF THE PREFERRED EMBODIMENTS

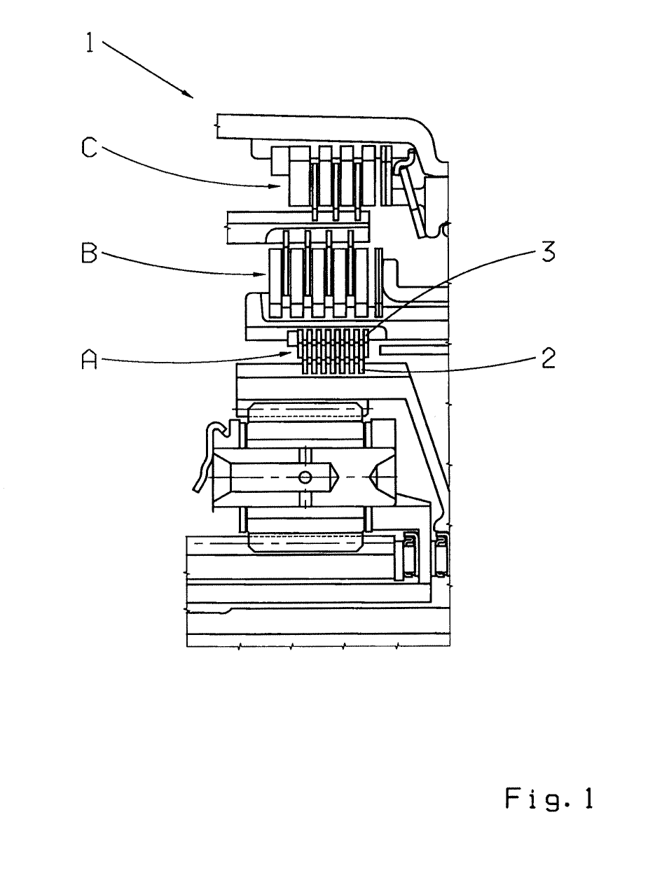

FIG. 1 shows a transmission 1 with a plurality of frictionally engaging shift elements A, B and C, which are engaged or disengaged in order to obtain various gear ratios. The frictional shift elements A to C, in this case, are in the form of disk shift elements, the shift element A being a disconnecting element which, for upshifts and in particular traction upshifts, is in each case disengaged to obtain gear ratios and is not engaged for any further traction upshift. The shift elements B and C are connecting elements of the transmission 1 which are engaged to obtain a gear ratio of the transmission 1, even for upshifts, in particular traction upshifts.

In addition, in the example embodiment of the transmission 1 shown in FIG. 1 the disconnecting element A is made both with unlined inner disks 2 and with unlined outer disks 3, whereas in a manner known per se the connecting elements B and C are made with lined disks. In this case the friction surfaces of the inner disks 2 and the outer disks 3 that can be brought into frictional engagement with one another consist of the same material as the remaining areas of the inner disks 2 and the outer disks 3, which are in this case made of steel.

The permissible surface pressure in the area of the friction surfaces of the disconnecting element A that can be brought into mutual frictional engagement, is higher than the permissible surface pressure in the area of the friction surfaces of the connecting elements B and C that can be brought into mutual frictional engagement. For the same transmission capacity, the disconnecting element A can be made smaller than in a design with lined disks, and thus gives rise to lower drag torques in the disengaged operating condition.

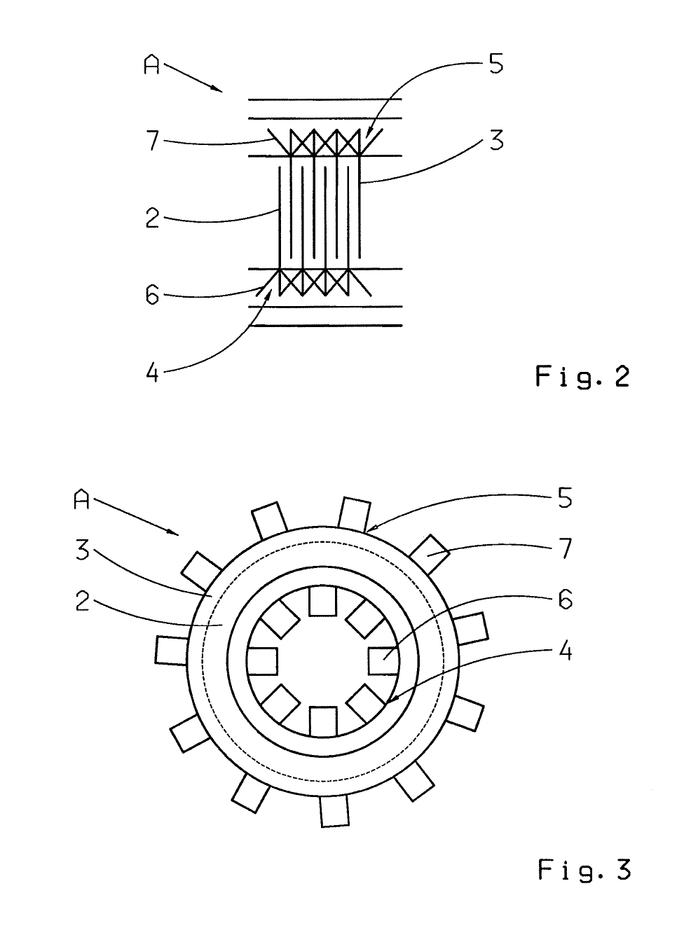

FIG. 2 shows an embodiment of the disconnecting element A alternative to that of FIG. 1, in which the inner disks 2, each in their inner edge area 4, and the outer disks 3, each in their outer edge area 5, are made at least in sections like cup springs. The cup-spring-like edge areas 4, 5 of the inner and outer disks 2, 3 of the disconnecting element A in FIG. 2 overhang the friction surfaces of the inner and outer disks 2, 3, respectively in different axial directions, so as to enable assembly of the inner and outer disks 2, 3 of the disconnecting element A as desired.

In the manner shown in more detail in FIG. 3, the inner edge areas 4 of the inner disks 2 and the outer edge areas 5 of the outer disks 3 are provided with drive-teeth 6, 7 which, in the manner shown in more detail in FIG. 2, are preferably offset in alternation in one axial direction and in the axial direction opposite thereto, in order to keep the inner disks 2 and the outer disks 3 respectively a distance apart so as to maintain a desired air gap between them in the disengaged operating condition of the disconnecting element A.

The transmission according to the invention can be constructed for example with the gearsets described in more detail in DE 102 44 023 A1. Furthermore, it is also possible to construct the transmission according to the invention as a Lepelletier-based transmission or even as a continuously variable multi-range transmission with synchronous range shifting by means of frictionally engaging connecting elements and frictionally engaging disconnecting elements.

### INDEXES

1 Transmission
2 Inner disks
3 Outer disks
4 Inner edge area of the inner disks
5 Outer edge area of the outer disks
6, 7 Drive-teeth
A Disconnecting element
B, C Connecting elements

1-9. (canceled)

10. A transmission (1) with a plurality of frictionally engaging shift elements (A, B, C) which are one of engaged and disengaged in order to obtain various gear ratios,
wherein a permissible surface pressure in an area of friction surfaces of each of at least second and third shifting elements (B, C), which are brought into mutually frictional engagement during upshifts to produce the gear ratios, is lower than a permissible surface pressure in an area of friction surfaces of a first shifting element (A) which can be brought into mutual frictional engagement which, in each case, is only disengaged during upshifts to produce the gear ratios.

11. The transmission according to claim 10, wherein the first shifting element (A) comprises disk shift elements which comprise outer disks (3), each having an outer edge area (5), and inner disks (4), each having an inner edge area (4), that are at least partially cup-spring-like shaped.

12. The transmission according to claim 11, wherein the edge areas (4, 5) of the inner and the outer disks (2, 3) respectively overhang the friction surfaces of the inner and the outer disks (2, 3) in different axial directions.

13. The transmission according to claim 10, wherein at least the friction surfaces of the inner and the outer disks (2, 3) of the first shifting element (A) are made from steel.

14. The transmission according to claim 10, wherein at least the friction surfaces of the inner and the outer disks (2, 3) of the first shifting element (A) are made from a sintered powder material.

15. The transmission according to claim 10, wherein at least the friction surfaces of the inner and the outer disks (2, 3) of the first shifting element (A) are made from molybdenum.

16. The transmission according to claim 10, wherein at least the friction surfaces of the inner and the outer disks (2, 3) of the first shifting element (A) are made from ceramic.

17. The transmission according to claim 10, wherein at least the friction surfaces of the inner and the outer disks (2, 3) of the first shifting element (A) are made from aluminum.

18. The transmission according to claim 10, wherein the first shifting element (A) has at least one disconnecting elements with a conical form.

19. A transmission (1) comprising at least second and third shifting elements (B, C) which are one of engaged and disengaged to implement a plurality of gear ratios, and a first shifting element (A) which is one of engaged and disengaged to implement a plurality of gear ratios,
wherein each of the second and the third shifting elements (B, C) have friction surfaces which apply a contact pressure on each other to respectively frictionally engage the second and the third shifting elements (B, C), the first shifting element (A) comprises inner and outer disks (2, 3) which apply a contact pressure on each other to frictionally engage the first shifting element (A),
the second and the third shifting elements (B, C) are engaged during upshifts to produce a gear ratio and the first shifting element (A) is only disengaged during upshifts to produce at least one gear ratio, and
the contact pressure applied by the friction surfaces of the second and the third shifting elements (B, C), for engaging the second and the third shifting elements (B, C), is lower than the contact pressure applied by the inner and the outer disks (2, 3) of the disconnecting element (A) for engaging the disconnecting element (A).
